(19) United States
(12) Patent Application Publication
(10) Pub. No.: US 2021/0255061 A1
(43) Pub. Date: Aug. 19, 2021

(54) METHOD FOR LEARNING MAPPING

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Naoya OKA, Nagakute-shi (JP)

(73) Assignee: TOYOTA JIDOSHA KABUSHIKI KAISHA, Toyota-shi, Aichi-ken (JP)

(21) Appl. No.: 17/168,383

(22) Filed: Feb. 5, 2021

(30) Foreign Application Priority Data
Feb. 14, 2020 (JP) 2020-023511

(51) Int. Cl. G01M 15/11; G06N 7/00; G06K 9/62; F02B 77/08

(52) U.S. Cl. CPC G01M 15/11; G06N 7/005; F02B 77/083; G06K 9/6215; G06K 9/6232; G06K 9/6256

(57) ABSTRACT

In a method for learning a mapping used by a computer, the mapping calculates a probability related to a categorization result using an internal combustion engine state variable as an input. The categorization result is a result of categorizing a state of an internal combustion engine into one of regions. The computer outputs the categorization result based on the calculated probability. The method includes inputting multiple training data to a training computer. The training data include the internal combustion engine state variable and the categorization result that is correct and associated with the internal combustion engine state variable. The method further includes updating the mapping based on the training data with the training computer. The training data are distributed to the regions and have a distribution density that is increased at locations closer to a border between the regions.

### BACKGROUND

### 1. Field

The following description relates to a method for learning a mapping.

### 2. Description of Related Art

Japanese Patent No. 6593560 describes a misfire detector of an internal combustion engine that stores a mapping in advance. The mapping includes a neural network and a softmax function that normalizes outputs of the neural network. The misfire detector inputs a parameter indicating a state of the internal combustion engine to the mapping and determines whether a misfire is present based on an output of the mapping. A mapping specified by mapping data is learned through machine learning by inputting training data in advance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technique described above determines the state of the internal combustion engine using the mapping learned through machine learning. In such a technique, as the amount of training data learned by the mapping increases, the accuracy of data output from the mapping is more likely to increase. However, it is impractical to collect an infinite amount of training data. Therefore, there is a need for a technique that increases the accuracy of data output from a mapping using a minimum amount of training data.

An aspect of the present disclosure provides a method for learning a mapping used by a computer. The mapping is configured to calculate a probability related to a categorization result using an internal combustion engine state variable as an input. The categorization result is a result of categorizing a state of an internal combustion engine into one of regions. The internal combustion engine state variable is a parameter indicating the state of the internal combustion engine. The computer is configured to output the categorization result of the state of the internal combustion engine based on the calculated probability. The method includes inputting multiple training data to a training computer. The training data include the internal combustion engine state variable and the categorization result that is correct and associated with the internal combustion engine state variable. The method further includes updating the mapping based on the input training data with the training computer. The training data are distributed to the regions and have a distribution density that is increased at locations closer to a border between the regions.

Other features and aspects will be apparent from the following detailed description, the drawings, and the claims.

### BRIEF DESCRIPTION OF THE DRAWINGS

FIG. 1 is a diagram showing configurations of a controller and a drive system of a vehicle.

FIG. 2 is a flowchart showing the procedure of a misfire detecting process executed by the controller shown in FIG. 1.

FIG. 3 is a flowchart showing the procedure of a misfire handling process executed by the controller shown in FIG. 1.

FIG. 4 is a diagram showing a system that generates mapping data used by the controller shown in FIG. 1.

FIG. 5 is a flowchart showing the procedure of a mapping learning method executed by the system shown in FIG. 4.

FIG. 6 is a chart showing distribution of training data used in the learning method shown in FIG. 5.

FIG. 7 is a chart showing distribution of training data used in the learning method shown in FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of a method for learning a mapping will be described below with reference to the drawings.

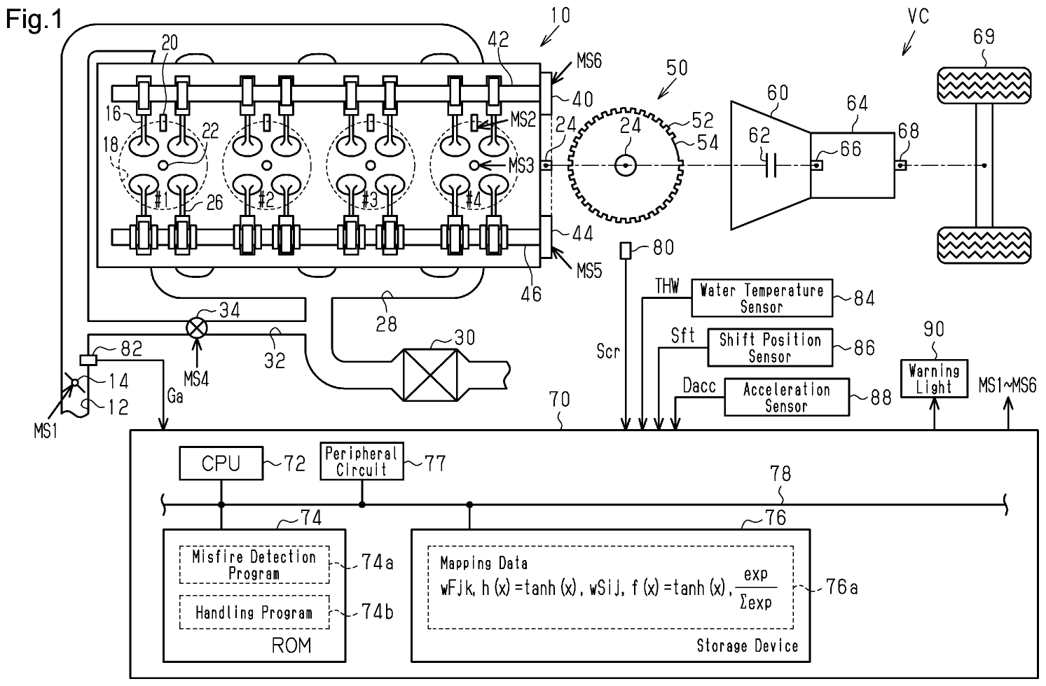

The configurations of a controller and a drive system of a vehicle in which a mapping is installed will now be described with reference to FIG. 1.

FIG. 1 shows a vehicle VC including an internal combustion engine 10 in which a throttle valve 14 is provided in an intake passage 12. Air drawn in from the intake passage 12 flows into combustion chambers 18 of cylinders #1 to #4 when respective intake valves 16 are open. The internal combustion engine 10 includes fuel injection valves 20 that inject fuel and ignition devices 22 that generate spark discharge, each of which is exposed into the respective combustion chambers 18. In the combustion chamber 18, a mixture of air and fuel is used in combustion, and energy generated by the combustion is converted into rotational energy of a crankshaft 24. The air-fuel mixture used in combustion is discharged as exhaust to an exhaust passage 28 when exhaust valves 26 are open. A three-way catalyst 30 having an oxygen storage capacity is provided in the exhaust passage 28. The exhaust passage 28 is connected to the intake passage 12 by an exhaust gas recirculation (EGR) passage 32. The EGR passage 32 is provided with an EGR valve 34 that adjusts the cross-sectional area of the EGR passage 32.

Rotational force of the crankshaft 24 is transmitted to an intake camshaft 42 via an intake valve timing variable device 40 and also transmitted to an exhaust camshaft 46 via an exhaust valve timing variable device 44. The intake valve timing variable device 40 changes a relative rotational phase difference between the intake camshaft 42 and the crankshaft 24. The exhaust valve timing variable device 44 changes a relative rotational phase difference between the exhaust camshaft 46 and the crankshaft 24.

The crankshaft 24 of the internal combustion engine 10 may be coupled to an input shaft 66 of a transmission 64 by a torque converter 60. The torque converter 60 includes a lock-up clutch 62. When the lock-up clutch 62 is in an engaged state, the crankshaft 24 is coupled to the input shaft 66. The transmission 64 has an output shaft 68 that is mechanically coupled to drive wheels 69. In the present embodiment, the transmission 64 is a multi-speed transmission configured to change the transmission ratio from the first speed to the fifth speed.

The crankshaft 24 is coupled to a crank rotor 50 including teeth 52. The teeth 52 respectively indicate (here, thirty-four) rotation angles of the crankshaft 24. The teeth 52 are basically arranged on the crank rotor 50 at 10° C.A (crank angle) intervals. The crank rotor 50 includes a toothless portion 54, which is defined by a portion between adjacent ones of the teeth 52 that are separated by 30° C.A. The toothless portion 54 indicates a reference rotation angle of the crankshaft 24.

The internal combustion engine 10 is controlled by a controller 70, which is a computer. The controller 70 operates the throttle valve 14, the fuel injection valves 20, the ignition devices 22, the EGR valve 34, the intake valve timing variable device 40, and the exhaust valve timing variable device 44 to control torque, an exhaust component ratio, and other control aspects of the internal combustion engine 10. FIG. 1 shows operating signals MS1, MS2, MS3, MS4, MS5, and MS6 of the throttle valve 14, the fuel injection valves 20, the ignition devices 22, the EGR valve 34, the intake valve timing variable device 40, the exhaust valve timing variable device 44, respectively.

When controlling the control aspects, the controller 70 refers to an output signal Scr of a crank angle sensor 80 and an intake air amount Ga detected by an airflow meter 82. The crank angle sensor 80 outputs a pulse at each angular interval between the teeth 52 (10° C.A except for the toothless portion 54). The controller 70 also refers to the temperature of coolant (water temperature THW) of the internal combustion engine 10 detected by a water temperature sensor 84, a shift position Sft of the transmission 64 detected by a shift position sensor 86, and acceleration Dacc of the vehicle VC in the vertical direction detected by an acceleration sensor 88.

The controller 70 is a computer that includes a mapping and an arithmetic unit. The controller 70 includes a central processing unit (CPU) 72, which is the arithmetic unit, a read-only memory (ROM) 74, an electrically rewritable nonvolatile memory (storage device 76), and a peripheral circuit 77, which are configured to communicate with each other through a local network 78. The peripheral circuit 77 includes, for example, a circuit that generates a clock signal regulating an internal operation of the controller 70, a power supply circuit, and a reset circuit.

The controller 70 controls the above-described control aspects by causing the CPU 72 to execute programs stored in the ROM 74. In addition, the controller 70 uses a mapping to calculate the probability of a misfire having occurred in the internal combustion engine 10 using various parameters, which indicate states of the internal combustion engine 10, as inputs. The CPU 72 of the controller 70 categorizes whether a misfire is present is absent in the internal combustion engine 10 based on the calculated probability.

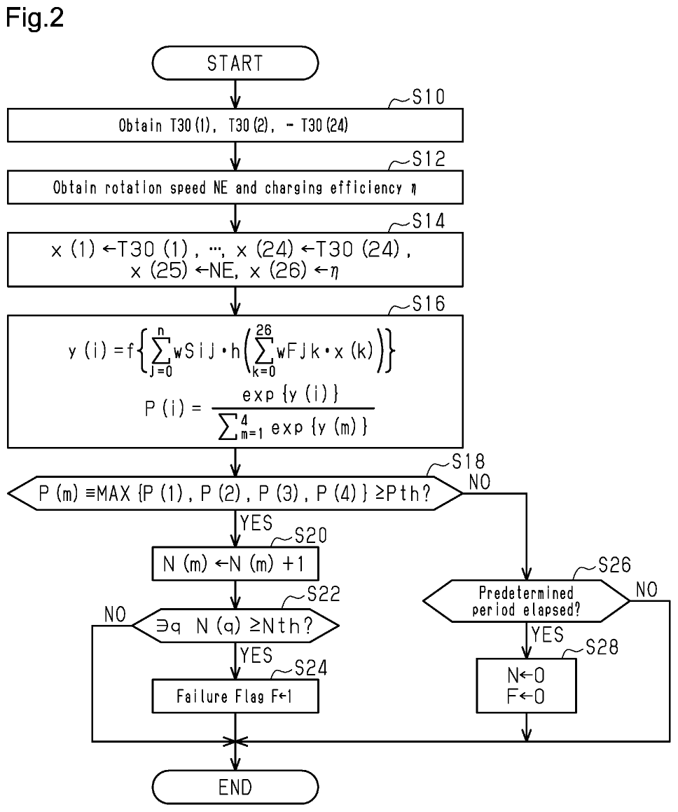

FIG. 2 shows the procedure of a misfire detecting process. The process shown in FIG. 2 is implemented by the CPU 72, for example, repeatedly executing a misfire detection program 74a stored in the ROM 74 shown in FIG. 1 in a predetermined cycle. In the following description, the step number of each process is represented by a numeral provided with an “S” prefix.

In a series of the processes shown in FIG. 2, the CPU 72 first obtains minute (i.e. very short) rotation times T30(1), T30(2), . . . T30(24), which are moment speed parameters (S10). The CPU 72 calculates minute rotation time T30 by measuring time taken for the crankshaft 24 to rotate 30° C.A based on the output signal Scr of the crank angle sensor 80. Different parenthesized numerals such as in minute rotation times T30(1) and T30(2) indicate different angular intervals in 720° C.A, which is one combustion cycle. That is, minute rotation times T30(1) to T30(24) show rotation times at each angular interval obtained by dividing a rotation angular range of 720° C.A by 30° C.A. Thus, minute rotation time T30 is a moment speed parameter at each 30° C.A, which is one of consecutive second intervals in 720° C.A, which is a first interval.

More specifically, the CPU 72 measures a time for the crankshaft 24 to rotate 30° C.A based on the output signal Scr and determines that the time is a pre-filtering time NF30. Then, the CPU 72 executes a digital filtering on the pre-filtering time NF30 to calculate a post-filtering time AF30. The CPU 72 normalizes the post-filtering time AF30 so that the difference between a local maximum value and a local minimum value of the post-filtering time AF30 in a predetermined period (e.g., 720° C.A) equals one to calculate minute rotation time T30.

Then, the CPU 72 obtains a rotation speed NE and a charging efficiency η (S12). The rotation speed NE is calculated by the CPU 72 based on the output signal Scr of the crank angle sensor 80. The charging efficiency η is calculated by the CPU 72 based on the rotation speed NE and the intake air amount Ga. The rotation speed NE is an average value of rotation speeds of the crankshaft 24 when rotated by an angular interval that is greater than an interval between compression top dead centers (in the present embodiment, 180° C.A). It is desirable that the rotation speed NE be an average value of rotation speeds of the crankshaft 24 when rotated by a rotational angle that is greater than or equal to one revolution of the crankshaft 24. The average value is not limited to a simple average and may be, for example, an exponential moving average and may be calculated by sampling values of minute rotation times T30 when the crankshaft 24 is rotated by a rotational angle that is greater than or equal to one revolution. The charging efficiency η is a parameter that determines the amount of air filling the combustion chambers 18.

The CPU 72 assigns the values obtained by the processes of S10 and S12 to input variables x(1) to x(26) of a mapping used to calculate a probability that a misfire has occurred (S14). More specifically, the CPU 72 assigns minute rotation time T30(s) to an input variable x(s) where s=1 to 24. That is, input variables x(1) to x(24) are time series data of minute rotation times T30. The CPU 72 assigns the rotation speed NE to an input variable x(25) and assigns the charging efficiency to an input variable x(26).

The CPU 72 inputs the input variables x(1) to x(26) to a mapping that is specified by mapping data 76a stored in the storage device 76 shown in FIG. 1 to calculate a probability P(i) that a misfire has occurred in each cylinder #i (i=1 to 4) (S16). The mapping data 76a specifies a mapping configured to output the probability P(i) that a misfire has occurred in each cylinder #i in a period corresponding to minute rotation times T30(1) to T30(24) obtained by the process of S10. The probability P(i) quantifies the plausibility that a misfire has actually occurred based on the input variables x(1) to x(26). In the present embodiment, the maximum value of the probability P(i) that a misfire has occurred in each cylinder #i is less than one, and the minimum value of the probability P(i) is greater than zero. Thus, in the present embodiment, the probability P(i) quantifies the plausibility that a misfire has actually occurred as continuous values in a predetermined range that is greater than zero and less than one.

In the present embodiment, the mapping includes a neural network having one intermediate layer and a softmax function. The softmax function normalizes outputs of the neural network so that the sum of the probabilities P(1) to P(4) that a misfire has occurred is one. The neural network includes an input coefficient wFjk (j=0 to n, k=0 to 26) and an activation function h(x), which is an input nonlinear mapping. The activation function h(x) performs nonlinear conversion on each output of an input linear mapping, which is a linear mapping specified by the input coefficient wFjk. In the present embodiment, a hyperbolic tangent “tan h(x)” is used as an example of the activation function h(x). The neural network further includes an output coefficient wSij (i=1 to 4, j=0 to n) and an activation function f(x), which is an output nonlinear mapping. The activation function f(x) performs nonlinear conversion on each output of an output linear mapping, which is a linear mapping specified by the output coefficient wSij. In the present embodiment, a hyperbolic tangent “tan h(x)” is used as the activation function f(x). A value n indicates a dimension of the intermediate layer. In the present embodiment, the value n is less than the dimensions (here, twenty-six dimensions) of an input variable x. The input coefficient wFj0 is a bias parameter. The input coefficient wFj0 defines an input variable x(0) as one and thus is a coefficient of the input variable x(0). The output parameter wSiO is a bias parameter and is multiplied by one. This may be obtained, for example, by identically defining “wF00·x(0)+wF01·x(1)+ . . . ” as infinity.

More specifically, the CPU 72 calculates a probability base y(i), which is an output of a neural network specified by the input coefficient wFjk, the output coefficient wSij, and the activation functions h(x) and f(x). The probability base y(i) is a parameter having a positive correlation with the probability that a misfire has occurred in each cylinder #i. The CPU 72 calculate the probability P(i) that a misfire has occurred in each cylinder #i using outputs of a softmax function into which the probability bases y(1) to y(4) are input.

The CPU 72 determines whether a maximum value P(m) of the probabilities P(1) to P(4) that a misfire has occurred is greater than or equal to a threshold value Pth (S18). The variable m has any value from 1 to 4. The threshold value Pth is set to a value greater than or equal to ½. If it is determined that the maximum value P(m) is greater than or equal to the threshold value Pth (S18: YES), the CPU 72 increments a misfire count N(m) of the cylinder #m having the maximum probability (S20). The CPU 72 determines whether any one of counts N(1) to N(4) is greater than or equal to a predetermined count Nth (S22). In the present embodiment, the process of S22 corresponds to a categorizing process. If it is determined that one of counts N(1) to N(4) is greater than or equal to the predetermined count Nth (S22: YES), the CPU 72 determines that misfires have occurred in a particular cylinder #q (q is one of 1 to 4) at a frequency exceeding an allowed range and assigns “1” to a failure flag F (S24). In this case, the CPU 72 keeps information of the cylinder #q in which misfires have occurred, for example, by storing the information in the storage device 76 at least until the misfire of the cylinder #q is resolved.

If it is determined that the maximum value P(m) is less than the threshold value Pth (S18: NO), the CPU 72 determines whether a predetermined period has elapsed from the process of S24 or S28 is executed (S26). The process of S28 will be described later. The predetermined period is greater than a period of a single combustion cycle and is, for example, greater than or equal to ten times one combustion cycle.

If it is determined that the predetermined period has elapsed (S26: YES), the CPU 72 initializes the counts N(1) to N(4) and also initializes the failure flag F (S28).

If the process of S24 or S28 is completed or a negative determination is made in the process of S22 or S26, the CPU 72 temporarily ends the series of the processes shown in FIG. 2.

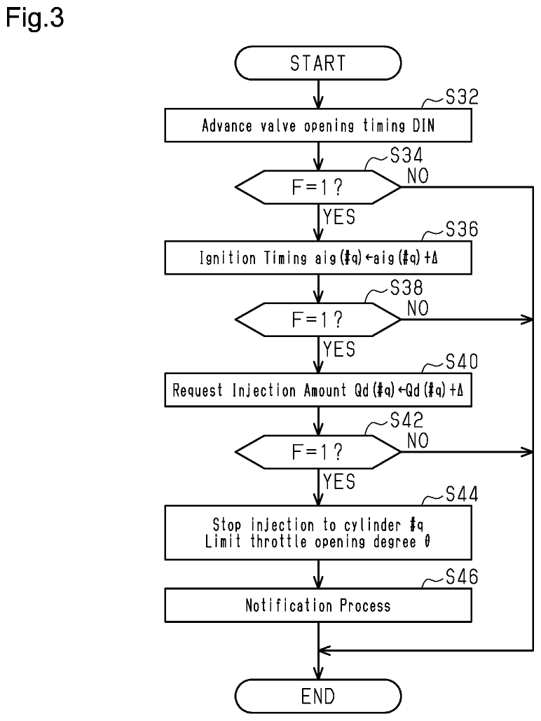

FIG. 3 shows the procedure of an operating process that handles a misfire when a misfire has occurred. The process shown in FIG. 3 is implemented by the CPU 72 executing a handling program 74b stored in the ROM 74 shown in FIG. 1 when the failure flag F is changed from “0” to “1”.

In a series of the processes shown in FIG. 3, the CPU 72 first outputs the operating signal MS6 to the intake valve timing variable device 40 to operate the intake valve timing variable device 40 so that a valve opening timing DIN of the intake valve 16 is shifted toward an advancement side (S32). More specifically, for example, in a normal state in which the failure flag F is “0”, the CPU 72 changes the valve opening timing DIN in accordance with an operation point of the internal combustion engine 10. In the process of S32, the CPU 72 advances the actual valve opening timing DIN from the valve opening timing DIN corresponding to the normal state. The process of S32 aims to increase the compression ratio of the air-fuel mixture to stabilize combustion.

After continuing the process of S32 for the above-described predetermined period or longer, the CPU 72 determines whether the failure flag F is “1” (S34). This process determines whether the process of S32 has resolved occurrence of the misfire. If it is determined that the failure flag F is “1” (S34: YES), for the cylinder #q in which a misfire is present, the CPU 72 outputs the operating signal MS3 to the ignition device 22 to operate the ignition device 22 and advance an ignition timing aig by a predetermined amount Δ (S36). This process aims to resolve occurrence of the misfire.

After continuing the process of S36 for the above-described predetermined period or longer, the CPU 72 determines whether the failure flag F is “1” (S38). This process determines whether the process of S36 has resolved occurrence of the misfire. If it is determined that the failure flag F is “1” (S38: YES), for the cylinder #q in which a misfire is present, the CPU 72 outputs the operating signal MS2 to the fuel injection valve 20 to operate the fuel injection valve 20. More specifically, the CPU 72 increases a request injection amount Qd, which is an amount of fuel requested by the fuel injection valve 20 in one combustion cycle, by a predetermined amount (S40). This process aims to resolve occurrence of the misfire.

After continuing the process of S40 for the above-described predetermined period or longer, the CPU 72 determines whether the failure flag F is “1” (S42). This process determines whether the process of S40 has resolved occurrence of the misfire. If it is determined that the failure flag F is “1” (S42: YES), for the cylinder #q in which a misfire is present, the CPU 72 stops fuel injection and adjusts the operating signal MS1, which is output to the throttle valve 14, to operate the throttle valve 14 while limiting the opening degree θ of the throttle valve 14 to a smaller value (S44). Then, the CPU 72 operates a warning light 90 shown in FIG. 1 to execute a notification process that notifies a misfire having occurred (S46).

If a negative determination is made in the process of S34, S38, or S42, that is, if occurrence of a misfire is resolved, or the process of S46 is completed, the CPU 72 temporarily ends the series of the process shown in FIG. 3. If an affirmative determination is made in the process of S42, the process of S44 continues as a fail-safe process.

A mapping learning method, that is, a method for learning the mapping data 76a included in a mapping, will now be described.

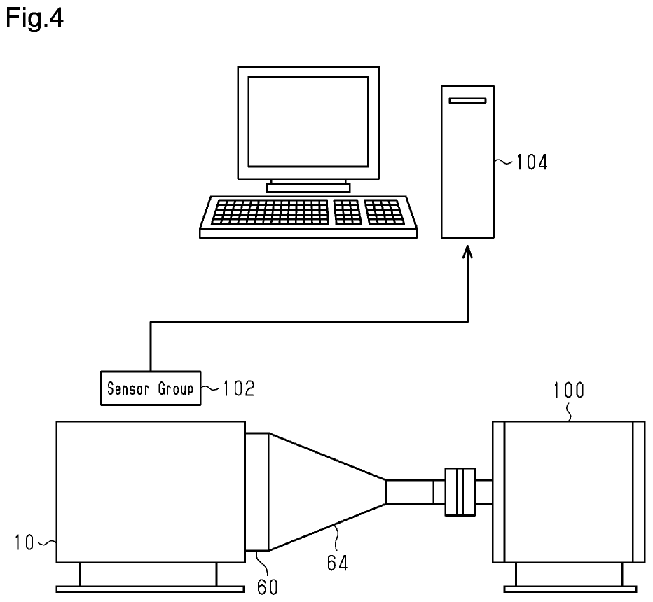

FIG. 4 shows a system that learns a mapping specified by the mapping data 76a.

As shown in FIG. 4, in the present embodiment, the crankshaft 24 of the internal combustion engine 10 is mechanically coupled to a dynamometer 100 by the torque converter 60 and the transmission 64. While the internal combustion engine 10 is running, a sensor group 102 detects various state variables, and the detection results are input to an adaptation device 104, which is a training computer configured to generate the mapping data 76a. The sensor group 102 includes various sensors that detect values used to generate inputs to the mapping and includes, for example, the crank angle sensor 80 and the airflow meter 82. The sensor group 102 includes, for example, an in-cylinder pressure sensor to assuredly determine whether a misfire is present.

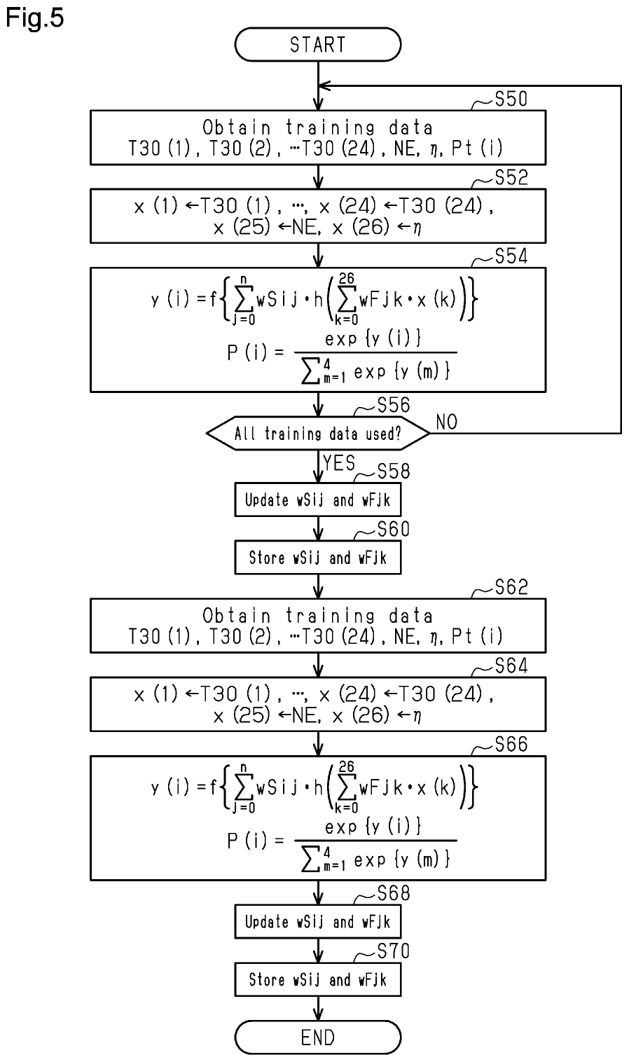

FIG. 5 shows the steps of the mapping learning method. The process of each step shown in FIG. 5 is executed by the adaptation device 104. The process of each step shown in FIG. 5 may be implemented, for example, by a CPU executing a program stored in a ROM when the adaptation device 104 includes the CPU and the ROM.

In a series of the steps shown in FIG. 5, the adaptation device 104 first obtains sets of minute rotation times T30(1) to T30(24), the rotation speed NE, the charging efficiency η, and a misfire true probability Pt(i) as training data determined based on detection results of the sensor group 102 (S50). Minute rotation times T30(1) to T30(24), the rotation speed NE, and the charging efficiency η are internal combustion engine state variables, which indicate states of the internal combustion engine. The true probability Pt(i) becomes one when a misfire is present, and becomes zero when a misfire is absent. The true probability Pt(i) is calculated based on, for example, a detection value of the in-cylinder pressure sensor, which is included in the sensor group 102 and configured to detect parameters other than parameters determining the input variables x(1) to x(26). When generating training data, for example, fuel injection of a predetermined cylinder may be intentionally stopped to produce a phenomenon similar to when a misfire occurs. Even in this case, the in-cylinder pressure sensor or the like is used to detect whether a misfire occurs in cylinders into which fuel is injected. More specifically, step S50 is a preliminary inputting step and inputs training data to the adaptation device 104. Training data input in the preliminary inputting step is preliminary training data.

In the same manner as the process of S14, the adaptation device 104 assigns training data excluding the true probability Pt(i) to the input variables x(1) to x(26) of a mapping used to calculate a probability of a misfire (S52). In the same manner as the process of S16, the adaptation device 104 calculates probabilities P(1) to P(4) of a misfire having occurred in the respective cylinders #1 to #4 (S54). The adaptation device 104 determines whether steps S50 to S54 have been executed on all of the training data detected by the sensor group 102 (S56). If it is determined that there is training data that has not been processed through steps S50 to S54 (S56: NO), the adaptation device 104 proceeds to step S50 and executes steps S50 to S54 on the unprocessed training data.

If it is determined that steps S50 to S54 have been executed on all of the training data detected by the sensor group 102 (S56: YES), the adaptation device 104 updates the input coefficient wFjk and the output coefficient wSij to minimize the cross entropy between the probability P(i), which was calculated in step S54, and the true probability Pt(i), which is a correct categorization result (S58). In the present embodiment, step S58 is a preliminary updating step. The adaptation device 104 stores the updated input coefficient wFjk and the updated output coefficient wSij as learned mapping data (S60).

As shown in FIG. 5, the adaptation device 104 obtains multiple training data that differ from the training data obtained in S50 (S62). The training data obtained in step S62 include training data such that the probability P(i) calculated by the mapping specified by mapping data stored in step S60 is closer to the threshold value Pth as compared to the training data obtained in S50. In the present embodiment, step S62 is an inputting step.

In the same manner as the process of S14, as performed in step S52, the adaptation device 104 assigns training data excluding the true probability Pt(i) to the input variables x(1) to x(26) of a mapping used to calculate a probability of misfire (S64). In the same manner as the process of S16, as performed in step S54, the adaptation device 104 calculates probabilities P(1) to P(4) that a misfire has occurred in the respective cylinders #1 to #4 (S66). The adaptation device 104 executes steps S64 and S66 on all of the training data input in S62. As performed in step S58, the adaptation device 104 updates the input coefficient wFjk and the output coefficient wSij to minimize the cross entropy between the probability P(i), which was calculated in step S66, and the true probability Pt(i), which is a correct categorization result (S68). In the present embodiment, step S68 is an updating step. The adaptation device 104 stores the updated input coefficient wFjk and the updated output coefficient wSij as learned mapping data (S70).

Upon completion of step S70, verification is performed on the accuracy of the probability P(i) calculated using the mapping specified by the input coefficient wFjk and the output coefficient wSij that are stored in step S70. If the accuracy is outside an allowed range, new training data is obtained, and steps S62 to S70 are repeated. When the accuracy is included in the allowed range, the input coefficient wFjk and the output coefficient wSij are used as the mapping data 76a implemented in the controller 70.

Training data obtained in S50 and S62 will be described.

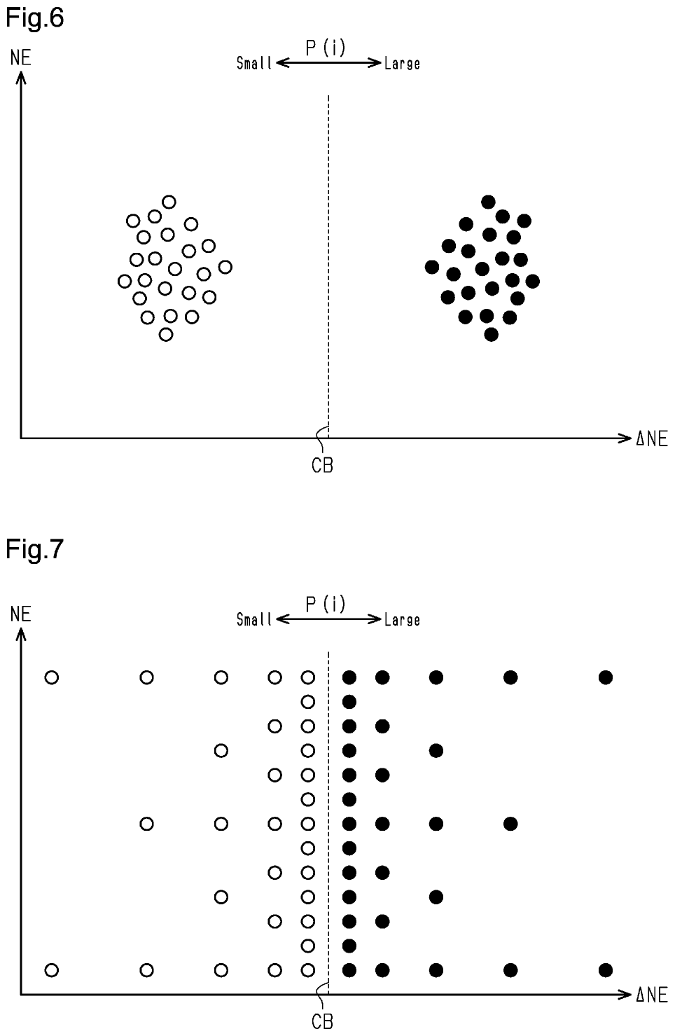

As shown in FIG. 6, in the preliminary inputting step of S50, each internal combustion engine state variable that is input as training data is categorized as a case in which a misfire is present and a case in which a misfire is absent based on values of the probability P(i). There is a strong correlation between the probability P(i) that a misfire occurs and a rotation change amount ΔNE, which is an amount of change in the rotation speed NE per unit time. More specifically, an increase in the rotation change amount ΔNE increases the probability P(i) that a misfire occurs, and a decrease in the rotation change amount ΔNE decreases the probability P(i) that a misfire occurs. Thus, the rotation change amount ΔNE is an index value indicating the probability P(i) of a misfire occurring.

For example, among training data that are input in the preliminary inputting step, it is considered that an average rotation change amount ΔNE between the minimum value of the rotation change amount ΔNE when a misfire occurs, and the maximum value of the rotation change amount ΔNE when a misfire does not occur, is close to a border of whether a misfire occurs in the internal combustion engine 10. In the present embodiment, the border between a region in which a misfire occurs and a region in which a misfire does not occur is defined as a categorization border CB, and the categorization border CB is tentatively determined on a two-dimensional map of the rotation change amount ΔNE and the rotation speed NE, which is a variable of training data other than the true probability Pt(i), as a two dimensional function passing through the average rotation change amount ΔNE. The categorization border CB indicates that the probability that a misfire occurs or the probability that a misfire does not occur is 50%. More specifically, the categorization border CB indicates that the probability that the internal combustion engine state variable is categorized in one of the two regions separated by the categorization border CB is 50%.

In the present embodiment, after the preliminary inputting step, the internal combustion engine 10 is driven in or beyond a predetermined range of the rotation speed NE, for example, in a range from zero to a few thousand rmp, which is expected in normal use, to obtain training data. The newly obtained training data are input to the two-dimensional map based on the rotation change amount ΔNE and the rotation speed NE that correspond to the time of obtaining the training data. Among the training data, training data that are close to the categorization border CB on the two-dimensional map are given priority of being used as training data in the inputting step of S62. As a result, as shown in FIG. 7, the distribution density of training data input in the inputting step of S62 is higher as the rotation change amount ΔNE is closer to the categorization border CB.

Although training data that are close to the categorization border CB are given priority and used as the training data input in the inputting step of S62, priority is not given to the training data based on whether the rotation speed NE is high or low. Therefore, the training data input in the inputting step of S62 are distributed in a wide range of the rotation speed NE from zero to a few thousand rpm on the two-dimensional map.

The operation and advantages of the embodiment will be described.

(1) It is newly found that when updating a mapping used to categorize a misfire of the internal combustion engine 10 as presence or absence, the accuracy of a categorization result is greatly affected by training data that are close to the border between presence and absence of a misfire in addition to the number of training data. In the above embodiment, the distribution density of training data input in step S62 is higher as the rotation change amount ΔNE is closer to the categorization border CB. Since the distribution density of training data is relatively high in the proximity of the categorization border CB, the mapping data is updated so that a correct categorization result is output. Input priority is given to training data that greatly affect the categorization result. Thus, the categorization result may be obtained from output of the mapping with high accuracy without preparing a large amount of training data that completely covers the entire range of the rotation change amount ΔNE.

(2) In the above embodiment, the categorization border CB is determined as a function on the two-dimensional map of the probability P(i) and the rotation speed NE. Even when the probability P(i) is the same, a change in the rotation speed NE may cause the mapping to output a categorization result having an error. In the above embodiment, the rotation speeds NE of training data are distributed in or beyond a certain range. This ensures the correctness of the mapping over the wide range of the rotation speed NE.

(3) In the above embodiment, the distribution density of training data input in step S62 is higher as the rotation change amount ΔNE is closer to the categorization border CB as compared to that of training data prepared in step S50. That is, input priority is given to training data having a greater effect on the categorization result. The controller 70 is likely to calculate the categorization result with high accuracy.

(4) In the above embodiment, the preliminary inputting step and the preliminary updating step are executed before the inputting step. Thus, as shown in FIG. 6, the categorization border CB is estimated based on the training data input in the preliminary inputting step. This allows for selection of a range of training data for obtaining a categorization result with high accuracy when selecting training data that are obtained in the inputting step.

### Other Embodiments

The above embodiment may be modified as follows. The embodiment and the following modified examples can be combined as long as the combined modified examples remain technically consistent with each other.

Categorization Border CB

In the above embodiment, the categorization border CB is a border line on the two dimensions of the rotation change amount ΔNE and the rotation speed NE. However, there is no limitation to such a configuration. The categorization border CB may be, for example, a border plane on three dimensions of the rotation change amount ΔNE, the rotation speed NE, and the charging efficiency η or may be a border plane on a greater number of dimensions. In such configurations, for example, the categorization border CB is a border plane that defines a space in which data indicating presence of a misfire in the internal combustion engine 10 are distributed. As described above, the categorization border CB may be determined to be a multidimensional function that includes the probability P(i) and at least one internal combustion engine state variable.

Rotation Change Amount ΔNE

In the above embodiment, the rotation change amount ΔNE is used as an example of a parameter that correlates with the probability of presence or absence of a misfire. However, other parameters may be used as long as the parameter correlates with likelihood of a misfire occurring.

Preliminary Inputting Step and Preliminary Updating Step

The relationship between the distribution density of training data input in the inputting step and the distribution density of input data input in the preliminary inputting step is not limited to the example described in the above embodiment. There may not be a large difference in the distribution density of training data between the inputting step and the preliminary inputting step. Even in this case, the number of training data is increased in total. Therefore, the accuracy of an output result of the mapping may be increased.

In the above embodiment, the preliminary inputting step and the preliminary updating step are executed before the inputting step. However, the preliminary inputting step and the preliminary updating step may be omitted. For example, when the categorization border CB can be estimated based on knowledge of an engineer without executing the preliminary updating step, training data that are input in the inputting step may be selected from multiple training data.

In the above embodiment, some of training data that are input to the adaptation device 104 in the inputting step may be selected by the adaptation device 104 and excluded from training data related to update of the mapping. For example, when the difference between the rotation change amount ΔNE corresponding to at the time of obtaining training data input in the inputting step and the categorization border CB that is calculated after the preliminary inputting step is greater than or equal to a predetermined value, the training data may be excluded from training data used in the updating step. As described above, when the adaptation device 104 selects training data used in the updating step, an engineer does not have to perform the training data selection.

First Interval and Second Interval

In the above embodiment, minute rotation times T30 are used as input parameters to the mapping for determining whether a misfire is present. Minute rotation times T30 are moment speed parameters at each of the consecutive second intervals in the rotation angular interval of 720° C.A, which corresponds to one combustion cycle. That is, the first interval is 720° C.A, and the second interval is 30° C.A. However, there is no limitation to such a configuration. For example, the first interval may be a rotation angular interval that is greater than 720° C.A. It is not essential that the first interval is greater than or equal to 720° C.A. For example, when inputting to a mapping that outputs generated torque or a probability that a misfire has occurred in a particular cylinder, the first interval may be less than or equal to 720° C.A, for example, 480° C.A. In this case, it is desirable that the first interval be a rotation angular interval that is greater than an interval between compression top dead centers. The first interval includes compression top dead center of a cylinder subject to calculation of the probability that a misfire has occurred.

The second interval is not limited to 30° C.A and may be an angular interval that is less than 30° C.A, and may be, for example, 10° C.A. The second interval is not limited to an angular interval that is less than or equal to 30° C.A and may be, for example, 45° C.A.

Moment Speed Parameter

The moment speed parameter is not limited to a minute rotation time, that is, a time taken to make a rotation of the second interval. For example, the moment speed parameter may be a value obtained by dividing the second interval by the minute rotation time. It is not essential that a normalization process be executed on the moment speed parameter so that the difference between a local maximum value and a local minimum value is a fixed value. The filtering, which is a pre-process for an input to the mapping, is not limited to that described above. The filtering may be, for example, a process that removes the effect on rotation of the crankshaft 24 caused by the input shaft 66 based on a minute rotation time of the input shaft 66 of the transmission 64. It is not essential that the filtering be executed on the moment speed parameter, which is an input to the mapping.

Parameter Specifying Operation Point of Internal Combustion Engine

In the above embodiment, the operation point is specified by the rotation speed NE and the charging efficiency 11. However, there is no limitation to such a configuration. The operation point may be specified by, for example, the rotation speed NE and the intake air amount Ga. As a load, for example, an injection amount or request torque of the internal combustion engine may be used instead of the charging efficiency η. Use of the injection amount or the request torque as the load is particularly advantageous to an internal combustion engine of compression ignition type described below in the section “Internal Combustion Engine”.

Input to Mapping

In addition to the moment speed parameter, inputs to the mapping are not limited to those described in the above embodiment and the above modified examples. An example of an input to the mapping may be a parameter related to the environment of the internal combustion engine 10. More specifically, the parameter may be, for example, an atmospheric pressure, which is a parameter affecting the rate of oxygen in intake air, an intake temperature, which is a parameter affecting the combustion speed of the air-fuel mixture in the combustion chambers 18, or humidity, which is a parameter affecting the combustion speed of the air-fuel mixture in the combustion chambers 18. A humidity sensor may be used to obtain the humidity. Alternatively, the state of a wiper or a detection value of a sensor that detects raindrops may be used. Another example of an input to the mapping may be data related to the state of an auxiliary device mechanically coupled to the crankshaft 24.

It is not essential that an input to the mapping includes the operation point of the internal combustion engine 10. For example, as described below in the section “Internal Combustion Engine”, when the internal combustion engine is mounted on a series hybrid vehicle and it is assumed that control is limited to a narrow range of operation points of the internal combustion engine, the operation point may be excluded.

Only one of the two parameters specifying the operation point, that is, the rotation speed NE and the load, or the rotation speed NE and the intake air amount, may be an input to the mapping in addition to the moment speed parameter.

Categorized State of Internal Combustion Engine

In the above embodiment, the categorization is based on whether a misfire is present in the internal combustion engine. However, the state of the internal combustion engine that is categorized is not limited to whether a misfire is present. The categorized state of the internal combustion engine may be, for example, whether or not the internal combustion engine is abnormal or whether a specified component of the internal combustion engine has a failure. At least, when calculating a categorization using an output of a mapping, the above mapping learning method is applicable.

As described in the embodiment, regarding whether a misfire is present in the internal combustion engine, the categorization border CB related to the rotation change amount ΔNE correlated with the probability P(i) may be estimated based on knowledge of an engineer. In such a case, the distribution density of training data in the proximity of the estimated categorization border CB may be readily increased. Therefore, when categorizing as presence or absence of a misfire in the internal combustion engine, the above mapping learning method is readily applicable.

Mapping

The neural network including a mapping that outputs the probability of a misfire is not limited to a neural network including a single intermediate layer. The neural network may include, for example, two or more intermediate layers.

The activation function h(x) is not limited to one using a hyperbolic tangent and may be, for example, a logistic sigmoid function. In the process shown in FIG. 2, the activation function f(x) is not limited to one using a hyperbolic tangent and may be, for example, a logistic sigmoid function. In this case, an output of the activation function f(x) may be used as a probability P without using a softmax function. In this case, probabilities P(1) to P(4) of a misfire having occurred in the respective cylinders #1 to #4 have independent values ranging from zero to one.

The mapping that outputs generated torque or the probability of a misfire is not limited to one using a neural network. The input coefficient wFij may be replaced with, for example, a coefficient specifying a parameter obtained by principal component analysis to reduce the dimensions of data obtained to be input to the mapping such as minute rotation times T30. An example of a process that embodies this configuration will be described as a modified example of the first embodiment. The principle component may be obtained using, for example, the following neural network. The neural network is a self-association mapping including a compression mapping and an output mapping. The compression mapping is a linear mapping that uses, as inputs, twenty-six dimensional parameters, namely, twenty-four minute rotation times T30, the rotation speed NE, and the charging efficiency 11, and outputs n-dimensional parameters where n<26. The output mapping is a linear mapping that uses the output of the compression mapping as an input and outputs twenty-six dimensional parameters. When components of a compression mapping are learned so that an error between the output and the input of the neural network is minimized, the compression mapping moves the input parameters to an n-dimensional space defined by the first n principal components in principal component analysis. Therefore, when the input coefficient wFjk (where k≥1) is replaced with a coefficient of the compression mapping, the coefficient of the compression mapping may be used as a substitute for linear combination of the input parameters in the first embodiment. In this case, each of the n principle components is input to the activation function h(x), outputs of the activation function h(x) are linearly combined by the output coefficient wSij and input to the activation function f(x). A regression expression in which the output of the activation function f(x) is generated torque or the probability base y(i) may be used to determine whether a misfire is present.

This case does not include the input coefficient wFj0, which is a bias parameter. The bias parameter may be added. In this case, it is desirable that the input coefficient wFj0, which is a bias parameter, be learned through the same process as in the first embodiment.

Moreover, for example, instead of using the above-described physical quantities as inputs to the neural network, some of the principle components related to the physical quantities may be used as inputs. In this case, since the principle components include a linear combination of minute rotation times T30(1) to T30(24), it is considered that an output of a linear mapping that uses minute rotation times T30(1) to T30(24) as inputs is input to the neural network.

The mapping is not limited to one using a linear combination of variables obtained in the processes of S10 and S12 as an input. This may be implemented by, for example, a support vector machine. More specifically, the mapping may be, for example, “w1·φ(T30(1),T30(2), . . . )+w2·φ2(T30(1),T30(2), . . . )+ . . . ” using appropriate basis functions φi (i=1, 2, 3, . . . ) having multidimensional independent variables and coefficients w1, w2, . . . determined based on a support vector. That is, the coefficients w1, w2, . . . may be learned so that the sign of an output of the above expression is inverted in accordance with whether a misfire has occurred. If the basis functions φ1, φ2, . . . include a function that does not use a linear combination of input parameters as an input, the function is an example in which a linear combination of input parameters is not input. The above expression may be specified so that, for example, when the output value has a positive sign, the probability that a misfire has occurred is zero, and when the output value is less than or equal to zero, the probability that a misfire has occurred is one. Thus, the mapping is configured to output the probability.

Output of Mapping

It is not essential that the probability P has continuous values in a mapping including a neural network. More specifically, the mapping may discretely or continuously output three or more values and, for example, may output three values corresponding to values of the plausibility that a misfire has actually occurred. Alternatively, the mapping may output two values.

Categorizing Process

The categorizing process is not limited to one that directly uses an output of a mapping configured to output the probability of a misfire having occurred. For example, in the process shown in FIG. 2, the rotation speed NE may be eliminated from the inputs to the mapping, and instead, the rotation speed NE may be used to correct the probability of a misfire, that is, an output. More specifically, for example, training data at a specific rotation speed NE may be used to generate mapping data. When the actual rotation speed NE is deviated from the specific rotation speed NE, the probability of a misfire output from the mapping may be increased. This process is an example of setting a margin taking into consideration that a deviation of the actual rotation speed NE from a rotation speed NE assumed by training data lowers the accuracy of the probability.

Such a process is not limited to correction that uses the rotation speed NE. In an example, instead of inputting an adjustment variable, which adjusts the combustion speed of the air-fuel mixture, to a mapping in addition to the moment speed parameter, the adjustment variable may be used as a parameter that calculates a correction amount that corrects a probability that is output from the mapping. In another example, instead of inputting a state variable of a driving device to a mapping in addition to the moment speed parameter, the state variable may be used as a parameter that calculates a correction amount that corrects a probability output from the mapping. In another example, instead of inputting a state variable of a road surface to a mapping in addition to the moment speed parameter, the state variable may be used as a parameter that calculates a correction amount that corrects a probability output from the mapping. In another example, instead of inputting the parameters described in the section “Input to Mapping” or “Parameter Specifying Operation Point of Internal Combustion Engine” to a mapping in addition to the moment speed parameter, the parameters may be used as parameters that calculate a correction amount that corrects a probability output from the mapping.

Notification Process

In the above embodiment, when a misfire is not resolved despite the processes of S32, S36, and S40 executed after the failure flag F becomes “1”, the warning light 90 is operated as the notification process. However, there is no limitation to such a configuration. For example, when the failure flag F becomes “1”, the notification process may be immediately executed.

In the above embodiment, the warning light 90 is operated to notify that a misfire has occurred with visual information. Instead, for example, a speaker may be operated to notify that a misfire has occurred with auditory information.

Operating Process

In the above embodiment, when the failure flag F becomes “1” and the misfire is not resolved by the process of S32, the process of S36 is executed. When the misfire is not resolved by the process of S36, the process of S40 is executed. However, there is no limitation to the configuration that sequentially executes the processes in order from S32 to S36 and then S40 for resolving a misfire. In an example, the processes may be executed in order from S36 to S40 and then S32. In another example, the processes may be executed in order from S40 to S36 and then S32. In another example, the processes may be executed in order from S40 to S32 and then S36.

The fail-safe process executed when the failure flag F becomes “1” is not limited to a process that executes the processes of S32, S36, S40, and S44. For example, only three, two, or one of the four processes S32, S36, S40, and S44 may be executed.

For example, as described below in the section “Internal Combustion Engine”, when an internal combustion engine of compression ignition type is used, a process that advances an injection timing may be executed instead of the process that advances an ignition timing (process of S36).

Training Data Generation

In the above embodiment, the training data is obtained when the internal combustion engine 10 is driven with the dynamometer 100 connected to the crankshaft 24 by the torque converter 60 and the transmission 64. Instead, the training data may be obtained, for example, when the internal combustion engine 10 is mounted on the vehicle VC and is driven.

The training data that is input in the inputting step may be data assumed from training data that is input in the preliminary inputting step. For example, when training data is obtained in the preliminary inputting step in a situation in which a misfire is assumed to be likely to occur, it may be difficult to obtain training data having a greater rotation change amount ΔNE in the inputting step. In this case, training data may be generated so that the rotation change amount ΔNE is increased by a predetermined amount from that of training data that is obtained in the preliminary inputting step.

Computer

The computer is not limited to one that includes the CPU 72 and the ROM 74 and executes software processing. The computer may include, for example, a dedicated hardware circuit (e.g., ASIC) configured to hardware-process at least some of the processes executed in the above embodiment. More specifically, the computer may be circuitry including any one of the following configurations (a) to (c). Configuration (a) includes a processor that executes all of the above-described processes according to programs and a program storage device such as a ROM that stores the programs. Configuration (b) includes a processor that executes some of the above-described processes in accordance with programs, a program storage device, and a dedicated hardware circuit that executes the remaining processes. Configuration (c) includes a dedicated hardware circuit that executes all of the above-described processes. Multiple software execution devices each including a processor and a program storage device and multiple dedicated hardware circuits may be provided.

In the above embodiment, the adaptation device 104, that is, a training computer, is separate from the controller 70, that is, a computer. However, the adaptation device 104 may be part of the controller 70. More specifically, the adaptation device 104 may be installed in the vehicle VC.

Storage Device

In the above embodiment, the storage device that stores the mapping data 76a is separate from the ROM 74 that stores the misfire detection program 74a. However, there is no limitation to such a configuration.

Internal Combustion Engine

In the embodiment, a direct injection valve that injects fuel into the combustion chamber 18 is illustrated as the fuel injection valve. The fuel injection valve may be, for example, a port injection valve that injects fuel into the intake passage 12. In another example, the internal combustion engine may include a port injection valve and a direct injection valve.

The internal combustion engine is not limited to a spark ignition type internal combustion engine and may be, for example, a compression ignition type internal combustion engine that uses, for example, light oil as fuel.

It is not essential that the internal combustion engine is configured to be a drive system. For example, the internal combustion engine may be mounted on a series hybrid vehicle that mechanically couples the crankshaft to an on-board power generator and disconnects transmission of power between the crankshaft and the drive wheels 69.

Vehicle

The vehicle is not limited to a vehicle in which the internal combustion engine is the only device that produces propulsion force of the vehicle. For example, a parallel hybrid vehicle or a series-parallel hybrid vehicle may be used as well as the series hybrid vehicle described in the section “Internal Combustion Engine”.

Others

A driving device arranged between the crankshaft and the driving wheels is not limited to a multi-speed transmission and may be, for example, a continuously variable transmission.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for learning a mapping used by a computer, wherein the mapping is configured to calculate a probability related to a categorization result using an internal combustion engine state variable as an input, the categorization result is a result of categorizing a state of an internal combustion engine into one of regions, the internal combustion engine state variable is a parameter indicating the state of the internal combustion engine, and the computer is configured to output the categorization result of the state of the internal combustion engine based on the calculated probability, the method, comprising:
inputting multiple training data to a training computer, wherein the training data include the internal combustion engine state variable and the categorization result that is correct and associated with the internal combustion engine state variable; and
updating the mapping based on the input training data with the training computer,
wherein the training data are distributed to the regions and have a distribution density that is increased at locations closer to a border between the regions.

2. The method according to claim 1, wherein
the border is determined as a multidimensional function including the probability and the internal combustion engine state variable, and
the training data are distributed to or beyond a fixed range of the internal combustion engine state variable included in the function.

3. The method according to claim 1, further comprising:
inputting multiple preliminary training data differing from the training data to the training computer before the training data are input; and
updating the mapping with the training computer based on the preliminary training data input to the training computer before the training data are input,
wherein the training data input after the preliminary training data are input are distributed to the proximity of the border at a greater density than the preliminary training data are distributed to the proximity of the border.

4. The method according to claim 1, further comprising:
inputting multiple preliminary training data differing from the training data to the training computer before the training data are input;
updating the mapping with the training computer based on the preliminary training data input to the training computer before the training data are input; and
using the mapping to calculate a probability from the training data input to the training computer; and
excluding the training data from training data that are used to update the mapping when a difference between the probability and the border is greater than or equal to a predetermined value.

5. The method according to claim 3, further comprising:
using the mapping to calculate a probability from the training data input to the training computer; and
excluding the training data from training data that are used to update the mapping when a difference between the probability and the border is greater than or equal to a predetermined value.

6. The method according to claim 1, wherein
the categorization result is whether a misfire is present in the internal combustion engine,
the mapping is configured to output a probability of a misfire having occurred in the internal combustion engine using time series data as an input,
the time series data include a moment speed parameter corresponding to each of second consecutive intervals included in a first interval,
the moment speed parameter is a parameter corresponding a rotation speed of a crankshaft of the internal combustion engine,
the first interval is a rotation angular interval of the crankshaft including compression top dead center,
the second interval is shorter than an interval at which the compression top dead center is reached,
the mapping is configured to output a probability of a misfire having occurred in at least one cylinder in which compression top dead center is reached within the first interval, and
the probability correlates with a rotation change amount, which is an amount of change in rotational behavior of the crankshaft of the internal combustion engine.
